(19) United States
(12) Patent Application Publication
(10) Pub. No.: US 2011/0206569 A1
(43) Pub. Date: Aug. 25, 2011

(54) ION EXCHANGER MOULDED BODY AND METHOD FOR PRODUCING SAME

(75) Inventors: Wolfgang Rohde, Speyer (DE); Veronika Wloka, Mannheim (DE)

(73) Assignee: BASF SE

(21) Appl. No.: 13/126,889

(22) PCT Filed: Oct. 30, 2009
(86) PCT No.: PCT/EP09/64350

§ 371 Date: Apr. 29, 2011

(30) Foreign Application Priority Data
Oct. 31, 2008 (EP) 08168021.7

(51) Int. Cl. B01J 39/20; C08J 9/26; B01J 8/02

(52) U.S. Cl. 422/187; 264/49; 521/33

(57) ABSTRACT

Organic polymer moldings with ion-exchanger properties or with adsorber properties are produced by means of a powder-based rapid-prototyping process in which a pulverulent organic polymer starting material or starting material mixture is applied in a thin layer to a substrate and then, at selected sites of this layer, is subjected to admixture of a binder and of any necessary auxiliaries, or is irradiated or otherwise treated, so that the powder becomes bonded at these sites, as a result of which the powder becomes bonded not only within the layer but also to the adjacent layers, and this procedure is repeated until the desired shape of the molding has been replicated completely in the resultant powder bed, and then the powder not bonded by the binder is removed, so that the bonded powder is retained in the desired shape, where the starting material itself has the ion-exchanger properties or adsorber properties, or appropriate functionalization of the molding takes place after the shaping process.

The invention relates to processes for the production of organic polymer moldings with ion-exchanger properties or with adsorber properties, and to moldings of this type, and to their use in heterogeneously catalyzed chemical reactions, or as adsorbers for the adsorption of ions or of chemical compounds.

Ion exchangers are substances which can use ions bound thereto to replace equivalent amounts of other ions from a surrounding solution. The charge on the ions involved in this exchange always has the same sign. Adsorber resins are unlike ion-exchanger resins in having non-ionic character; the polarity of which depends on the structure, and they adsorb anions, cations, and also uncharged species, in a non-stoichiometric process.

Ion-exchanger resins and adsorber resins typically involve gel-type or macroreticular, spherical, porous synthetic resins based on styrene or on acrylic resin. A three-dimensionally crosslinked material is generally used, typically obtained by concomitant use of divinylbenzene. The exchanger resins are therefore not thermally deformable, and are free from plasticizers, with practically no possibility of release of soluble fractions.

The ion exchangers most frequently used nowadays are polystyrene resins crosslinked with divinylbenzene (DVB), thus exhibiting a high level of three-dimensional high-molecular-weight structure, mostly having spherical shape.

Sulfonation of the crosslinked polystyrene resin, e.g. with oleum, produces a strongly acidic cation exchanger. To produce weakly acidic cation exchangers, acrylic acid derivatives, rather than styrene, are crosslinked with divinylbenzene. Anion exchangers, too, can be strongly basic or weakly basic. Exchanger resins having a quaternary ammonium group exhibit strongly basic character, while resins having tertiary amino groups have weakly basic properties. The ion exchangers are typically used in the form of solid spheres, and these can be used in the form of a fixed bed to pack through-flow reactors.

The geometries of the ion-exchanger resins and adsorber resins are therefore subject to very great restriction, and there is only limited scope for adapting them to the respective requirements, for example in relation to resistance to flow, surface area, etc.

It is an object of the present invention to provide a process for the production of organic polymer moldings with ion-exchanger properties or with adsorber properties, which permits the production of a wide variety of molding geometries in a simple manner, and thus can adapt the ion exchangers and adsorbers to the respective application.

According to the invention, the object is achieved through a process for the production of organic polymer moldings with ion-exchanger properties or with adsorber properties, by means of a powder-based rapid-prototyping process in which a pulverulent organic polymer starting material or starting material mixture is applied in a thin layer to a substrate and then, at selected sites of this layer, is subjected to admixture of a binder and of any necessary auxiliaries, or is irradiated or otherwise treated, so that the powder becomes bonded at these sites, as a result of which the powder becomes bonded not only within the layer but also to the adjacent layers, and this procedure is repeated until the desired shape of the molding has been replicated completely in the resultant powder bed, and then the powder not bonded by the binder is removed, so that the bonded powder is retained in the desired shape, where the starting material itself has the ion-exchanger properties or adsorber properties, or appropriate functionalization of the molding takes place after the shaping process.

The ion exchangers or adsorbers here can serve as catalyst for a wide variety of reactions using acidic or basic heterogeneous catalysis, or for the purification or separation of chemical mixtures, e.g. for treatment of wastewater, or in analysis, or as guard bed.

Because of the variety of types of adsorber applications and, respectively, heterogeneously catalyzed reactions, it is possible to use various structural forms which are intended to ensure ideal transport of material and of heat for the respective application. In the case of beds, the catalyst/adsorber is present in random form in the reactor, but in a packing it is in oriented form, incorporated non-randomly into the reactor. The most widespread use of catalysts is in the form of pellets, extrudates, tablets, rings, or split, these being introduced in the form of a bed into the reactor. However, a disadvantage with this usage form is that the beds described generally lead to a large pressure loss within the reactor. Another frequent phenomenon is formation of channels and development of zones with stagnating gas movement and/or stagnating liquid movement, the result being very non-uniform loading of the catalyst. The requirement for removal and installation of the moldings can also cause complication, for example in the case of tube-bundle reactors with a large number of tubes.

For particular applications, it is also possible to use catalyst/adsorbers in the form of monoliths with continuous channels, or a honeycomb structure or rib structure, these being described by way of example in DE-A-2709003. The process of the invention permits the production of organic polymer moldings with ion-exchanger properties or with adsorber properties with any desired suitable geometry. This production takes place by the rapid-prototyping process, which is explained below.

“Rapid-Prototyping” Manufacturing Process

The term “rapid prototyping” (RP) is familiar to the person skilled in the art for a manufacturing process which is used for sample components and which can provide direct and rapid production of even very highly detailed workpieces with almost any desired geometry, starting from available CAD data, with a minimum of manual intervention or use of molds. The rapid-prototyping principle is based on the layer-by-layer construction of components, using physical and/or chemical effects. There are a number of well-established processes here, examples being selective laser sintering (SLS) or stereolithography (SLA). The actual processes differ in relation to the material used for construction of the layers (polymers, resins, paper webs, powders, etc.) and in relation to the method used to bond said materials (laser, heating, binder, or binder systems, etc.). The processes have been described in numerous publications.

One of the rapid-prototyping processes is described in EP-A0431 924, and comprises the layer-by-layer construction of three-dimensional components composed of powder and binder. Non-bound powder is finally removed, and the workpiece is retained with the desired geometry.

WO 2004/112988 discloses that it is also possible to use more than one pulverulent starting material, and US 2005/0017394 discloses the use of activators which induce the hardening of the binder.

According to the invention, therefore, the object is achieved through the use of moldings with geometry optimized for the respective flow conditions and reaction conditions in the reactor or in the adsorber bed, etc. As a function of the required reaction conditions, the reactor internals can be produced in a manner tailored for the application, this being impossible with conventional techniques. The advantage of rapid-prototyping technology over these conventional manufacturing techniques is that in theory it is possible, by using a CAD data set and computer control, to convert any desired geometry into the corresponding three-dimensional component without prior replication in casting molds, and without removing material by cutting, milling, grinding, etc., even in the case of complex moldings, for example those with cavities or with microchannels. This method permits the production of reactor internals whose optimized geometry provides advantages for the transport of materials and of heat in chemical reactions, when comparison is made with conventional reactor internals. This intensivization of the process gives higher yields, conversions, and selectivities, and also makes conduct of the reaction more reliable, and can lead to cost savings for existing or new processes in the chemical industry, by virtue of reduced apparatus sizes or smaller amounts of catalyst.

According to the invention, organic polymer moldings are produced with ion-exchanger properties or with adsorber properties. These generally involve gel-type or macroreticular porous synthetic resins. The pulverulent starting materials are generally based on poly(meth)acrylic acids, or on poly(meth)acrylates, or on polystyrene, if appropriate crosslinked. The synthetic resins are typically based on styrene resins or on acrylic resins. Crosslinking monomers, in particular divinylbenzene, are generally used to achieve three-dimensional crosslinking. The exchanger resins are therefore not thermally deformable, and are at the same time free from plasticizers. There is practically no possibility of release of soluble fractions. However, it is also possible to use uncrosslinked polymers, which can be crosslinked subsequently through introduction of suitable crosslinking agents or through radiation, e.g. using electron beams, in the finished molding. Crosslinking agents can have been incorporated into the polymer itself, and can be used for hardening after shaping. By way of example, therefore, silanes can be introduced as crosslinking agents into the polymer.

The person skilled in the art is aware of suitable molecular weights and of the production of the polymer resins, in particular polystyrene resins or polyacrylic resins. The resins used in the rapid-prototyping process used according to the invention do not differ in this respect from the typical ion-exchanger resins or typical adsorber resins.

Powder Form

The rapid-prototyping process to be used according to the invention uses pulverulent starting materials, which can be used with or without binder. The statements below apply to both variants. It is possible to use either monodisperse or polydisperse powders. Finer particles here can naturally achieve thinner layers, the result being that a desired molding can be constructed using a larger number of layers and therefore greater spatial resolution than when coarser particles are used. It is preferable to use powder whose average particle size is in the range from about 0.5 μm to about 450 μm, particularly from about 1 μm to about 300 μm, and very particularly from 10 to 100 μm. The powder to be used can, if necessary, also have been subjected to specific pretreatment, e.g. by at least one of the following steps: compacting, mixing, pelletizing, sieving, agglomerating, or grinding, to give a certain particle size fraction by introduction of additives, such as crosslinking agents, surface treatment to improve adhesion in the bonding process, e.g. through plasma treatment, corona treatment, acid treatment (HNO₃, H₂SO₄), ozone, UV, etc., or else introduction of carbon blacks to improve adsorption of IR radiation. Suitable polymer materials are described by way of example in WO 2005/010087, WO 03/106148, EP-A-0 995 763, and U.S. Pat. No. 7,049.363.

Production

The rapid-prototyping process to be used according to the invention is composed, as is known, of the following steps, which are to be repeated until the desired molding has been constructed completely from the individual layers. A pulverulent starting material or starting material mixture is applied in a thin layer to a substrate and then, at selected sites of this layer, is subjected to admixture of a binder and of any necessary auxiliaries, or is irradiated or otherwise treated, so that the powder becomes bonded at these sites, as a result of which the powder becomes bonded not only within the layer but also to the adjacent layers. This procedure is repeated until the desired shape of the workpiece has been replicated completely in the resultant powder bed, and then the powder not bonded by the binder is removed, and the bonded powder is retained in the desired shape.

Processes which can in particular be used are the SoluPor® process, or the PolyPor® process. In the SoluPor® process, the polymer particles are adhesive-bonded by a purely physical method at the desired sites. Once the shape has been constructed layer-by-layer, the solvent is driven off. In the PolyPor® process, the polymer particles are solvated by a reactive solvent at the desired sites, and this is then polymerized by an initiator which has been released. The residual monomer is driven off.

Binders and Auxiliaries

The binders used can generally comprise any material which is suitable for achieving secure bonding between adjacent particles of the pulverulent starting material. Preference is given here to organic materials, particularly those which can be crosslinked or can enter into covalent bonding with one another in any other manner, examples being phenolic resins, polyisocyanates, polyurethanes, epoxy resins, furan resins, urea-aldehyde condensates, furfuryl alcohol, acrylic acid dispersions and acrylate dispersions, polymeric alcohols, peroxides, carbohydrates, sugars, sugar alcohols, proteins, starch, carboxymethylcellulose, xanthane, gelatin, polyethylene glycol, polyvinyl alcohols, polyvinylpyrrolidone, or a mixture thereof. The binders are used as liquids, in either dissolved or dispersed form, and it is also possible here to use organic solvents (e.g. toluene) or water. According to one embodiment of the invention, the binder is a solvent which at least superficially solvates the polymer starting material, thus producing bonding between the powder particles. The solvated polymer particles bond adhesively to one another, producing a secure bond. According to another embodiment, the pulverulent starting material comprises a reactive compound which is reacted with an applied activator compound, thus producing bonding of the polymer starting materials. The reactive compound can by way of example be a monomer which is also comprised within the structure of the polymer starting material. Examples of materials that can be involved here are therefore styrene, acrylate, or acrylic acid.

The binders are applied by way of example by way of a nozzle or a printing head, or by way of any other apparatus which permits precise placing of minimum-size droplets of the binder on the powder layer. A ratio of amount of powder to amount of binder varies as a function of the substances used, and is generally in the range from about 40:60 to about 99:1 parts, by weight, preferably in the range from about 70:30 to about 99:1 parts by weight, particularly preferably in the range from about 85:15 to about 98:2 parts by weight.

One or more auxiliaries can moreover be used, if appropriate, and by way of example can have an effect on the crosslinking of the binders, or can serve as hardeners. The auxiliaries can be applied separately, but, if appropriate, can also be added to the powder bed and/or to the binder or to the binder solution. The binding process can also be improved by treatment with radiation, e.g. in the UV region or IR region, see also the description of surface treatment above.

The shaping process can then be followed by heat treatment, in order to improve crosslinking or reaction of the binders. According to the invention, the polymeric starting material can, prior to or after the shaping process, be functionalized with acidic groups, with basic groups, or with chelating groups. The method for this functionalization is the same as that for the production of ion-exchanger resins or of adsorber resins. It is therefore possible to use finished ion-exchanger-resin powders or adsorber-resin powders in the rapid-prototyping process, or to begin by using resins which have not yet been functionalized and then to functionalize the moldings produced.

Strongly acidic ion exchangers are typically based on polystyrene and are sulfonated with sulfuric acid (oleum), so that sulfonic acid groups are present, bound to the phenyl group, in the molding. Another possibility is the reaction with perfluorosulfonic acid, cf. Applied Catalysis A: General 221 (2001) 45-62. Ion exchangers which are more weakly acidic are typically based on polyacrylates which have free carboxy groups. These can be obtained by basic hydrolysis of the ester groups. It is also possible to use phenol-formaldehyde gels.

Basic ion exchangers can be divided into strongly basic and weakly basic ion-exchanger resins as a function of the solid-state ions present. Exchanger resins having a quaternary ammonium group exhibit strongly basic character, while resins having tertiary amino groups have weakly basic properties. Examples of suitable basic groups are —N⁺(CH₃)₂(CH₂OH), —N⁺(CH₃)₃, —N(R)₂, where R=alkyl, such as —N(CH₃)₂, —NH—CH₂—CH₂—NH₂. Basic ion exchangers can by way of example be obtained starting from polystyrene through reaction with methyl chloromethyl ether and subsequent reaction of the resultant —CH₂Cl groups with secondary or tertiary alkylamines. It is also possible to provide, within the ion exchangers, thiourea groups, or groups that bind or chelate metal ions. The active centers are usually used to modify the polymer, thus adjusting the adsorption properties or ion-exchanger properties.

The surface areas of the organic polymers are preferably in the range from 5 to 200 m²/g, particularly preferably from 10 to 100 m²/g, in particular from 20 to 70 m²/g. The average pore diameter is preferably from 2 to 200 nm, in particular from 10 to 100 nm. In the case of functionalization, the amount present of functional or ionic groups is preferably from 0.1 to 15 eq/kg, particularly preferably from 0.5 to 10 eq/kg, in particular from 1 to 7 eq/kg, specifically from 2 to 6 eq/kg.

The degree of functionalization determines inter alia the overall capacity of the ion-exchanger resins.

Geometry of the Moldings

The geometry of the moldings depends on the requirements of the respective application sector, and can be varied widely, because the powder-based rapid-prototyping process is flexible. By way of example, the organic polymer moldings with ion-exchanger properties or with adsorber properties can have one or more channels which are open to the exterior and which run through the molding. By way of example, an ion-exchanger medium can flow through these channels. This type of molding preferably has from two to 100, particularly preferably from 4 to 50, channels. The channels pass through the molding and are open at the site of entry and the site of exit.

The organic polymer molding with ion-exchanger properties or with adsorber properties, can, as an alternative or in addition, have a surface area/volume ratio which is at least twice as great, preferably at least three times as great, as the surface area/volume ratio of a sphere with identical volume. Organic ion exchangers have generally been used in spherical form hitherto. The moldings according to the invention permit substantially improved ion exchange, by increasing the surface area available for the exchange process.

The organic polymer moldings with ion-exchanger properties or with adsorber properties can also have the shape of a monolith, and through which a fluid medium can flow, where the monoliths have channels which have inclination at an angle in the range from 0° to 70°, preferably from 30° to 60°, with respect to the main direction of flow. These monoliths can also have the stated number of channels and the stated surface area/volume ratio.

A preferred desired shape is one whose use as adsorber or catalyst in heterogeneously catalyzed chemical reactions maximizes cross-mixing and minimizes pressure loss in the reactor, and also gives only a low level of back-mixing against the direction of flow, and gives sufficient transport of materials and of heat, including transport of heat toward the exterior. Advantageous shapes can by way of example be based on the intersecting-channel structures of packings known in distillation technology, these being known to the person skilled in the art, and supplied by producers such as Montz, Sulzer or Kühni. The channels can have any desired cross-sectional shape, but preference is given to square, rectangular, or round cross-sectional shapes.

The packings can preferably have been designed as multi-channel packings having channels in which the chemical reaction preferably takes place, and also including channels in which convective transport of heat preferably takes place. The channels for the transport of heat preferably have greater inclination and preferably have a hydraulic diameter greater by a factor of from 2 to 10 than the diameter of the channels for catalysis.

However, decisive advantages over the existing shapes are also possessed by monolithic structures with advantageously arranged holes and/or apertures which connect the individual channels to one another and thus increase the intensity of cross-mixing.

Incorporation of the Moldings Within Reactors, Adsorption Beds, and Purification Beds

The moldings used according to the invention are used as reactor internals. In this function, they can be present in unoriented form as a bed, or in spatially oriented form, for example as packing in a column-shaped reactor, as is in principle known for monoliths. The moldings used according to the invention here can extend as far as the edge of the (column-shaped) reactor. There are various methods for incorporating the structured catalysts into the reactor, e.g. they can be incorporated into a tubular or tube-bundle reactor by arranging the cylindrical components one on top of the other, but it is not necessary here that all of the catalyst parts have the same shape, structure, functionalization, etc. Vertical/longitudinal segmentation systems are also possible. They can also be incorporated in transversally segmented form (for example as in segments of a cake by using 4 quarter-cylinders, or by using a number of hexagonal, honeycomb-like components, arranged alongside one another).

Each packing element can be composed of a multiplicity of longitudinally oriented layers, where each layer comprises closely arranged channels, and the channels of adjacent layers cross, and the channels within a packing element have sidewalls which are permeable or impermeable to the fluids.

In order to increase resistance to flow at the edges, the packings are preferably either a) equipped with an edge seal, in order to ensure uniform flow through the material across the entire cross section of the packing, or b) preferably have a structure which does not have higher porosity at the edge.

The invention also provides corresponding packing elements.

Examples of Geometry

Suitable shapes or structures of the moldings used according to the invention are described by way of example in the following publications from the companies Montz and Sulzer. Structures that may be mentioned by way of example are those described in WO 2006/056419, WO 2005/037429, WO 2005/037428, EP-A-1 362 636, WO 01/52980, EP-B-1 251 958, DE-A-38 18 917, DE-A-32 22 892, DE-A-29 21 270, DE-A-29 21 269, CA-A-10 28 903, CN-A-1 550 258, GB-A-1 186 647, WO 97/02880, EP-A-1 477 224, EP-A-1 308 204, EP-A-1 254 705, EP-A-1 145 761, U.S. Pat. No. 6,409,378, EP-A-1 029 588, EP-A-1 022 057, and WO 98/55221. Another suitable molding takes the form of a crossed-channel packing, where the packing is composed of vertical layers composed of corrugated or pleated metal oxides which form flow channels, and the flow channels of adjacent layers have open crossing points, and the angle between the crossing channels is smaller than about 100°. This type of crossed-channel packing is described by way of example in EP-A-1 477 224. See also the angle definition in that document.

Examples of the packings that can be used as moldings are Sulzer BX gauze packings, Sulzer Mellapak lamellar packings, high-performance packings, such as Mellapak Plus, and structured packings from Sulzer (Optiflow), Montz (BSH), and Kühni (Rombopak), and also packings from Emitec (www.emitec.com).

The moldings can by way of example have the shape of the following types of packing: A3, B1, BSH, C1, and M from Montz. These packings are composed of corrugated webs (lamellae). The corrugations run at an angle inclined to the vertical, and form intersecting flow channels with the adjacent lamellae.

Sizes of monoliths can be freely selected. Typical preferred monolith sizes are in the range from 0.5 to 20 cm, in particular from 1 to 10 cm. It is also possible to produce larger monoliths composed of monolith segments.

The moldings according to the invention can be used with particular preference when the spheres available from known ion exchangers are too small, or excessive pressure losses or by-pass phenomena occur.

Applications

The ion exchangers or adsorbers produced according to the invention can be used in a wide variety of applications. Firstly, they can be used as adsorbers for a wide variety of different ions, and chemical compounds. It is possible here to bind any of the metal ions comprised in aqueous or organic liquid systems, examples being alkali metal ions or alkaline earth metal ions, or heavy metal ions, or else other metal ions, ammonium ions, or anions. The adsorber resins here can be used for wastewater purification. The geometry here is selected in such a way as to achieve ideal adsorption of the metal ions from the solution flowing through the material, while achieving ideal throughput. Adsorption properties here can change with pH.

The ion exchangers can also be used to reduce water hardness. Anion exchangers can be used to remove undesired anions from liquid systems, examples being sulfates, nitrates, or halides, such as chlorides or iodides.

Chelating ion exchanges can be used for trace enrichment. The total salt content of solutions, or of water, can be determined, and undesired cations or anions can be removed using cation exchangers or anion exchangers, and chromatographic separation can be achieved. The moldings can also be used for disaggregation of sparingly soluble compounds.

After the ion-exchange process, the molding is typically washed and regenerated or eluted, so that it can be used for further applications.

Preferred application sectors are water treatment, such as water softening unit, partial or full desalination, separation of rare earths, separation of amino acids, and analytical uses. Preference is also given to the removal of high-molecular weight organic compounds or dyes. Other preferred application sectors are the purification and production of antibiotics, vitamins, and alkaloids, the purification of enzymes, and the adsorption of dyes. Another preferred application sector is the isolation and determination of acids and alkalis, and the removal of undesired cations and anions.

A prime application sector for the ion exchangers is catalysis.

It has long been known that mineral acids, such as hydrochloric or sulfuric acid, and alkaline solutions, such as sodium hydroxide solution and potassium hydroxide solution, can be used for the catalysis of esterification reactions, saponification reactions, condensation reactions, rearrangement reactions, hydrolysis reactions, polymerization reactions, dehydration reactions, or cyclization reactions. The moldings according to the invention provide products, in the form of carriers of exchangeable counterious, these being precisely the same as mineral acids or alkali solutions in so far as they comprise catalytically active hydrogen ions or catalytically active hydroxy ions, and similarly exhibit a direct catalytic effect. It is therefore possible to use strongly acid cation exchangers in the H⁺ form instead of mineral acids for acid-catalyzed reactions, and strongly basic ion exchangers in the OH⁻ form can be used for base-catalyzed reactions.

The catalysts in the form of moldings have many advantages over homogeneous acid catalysts or homogeneous base catalysts: because they take the form of moldings, they can readily be removed through the reaction product. In most cases, they can be used again immediately without regeneration. Selectivity with respect to larger or smaller molecules is possible. They can be used in the continuous conduct of reactions. They inhibit the entrainment of foreign ions into the reaction product. They avoid undesired secondary reactions and undesired side-reactions, thus increasing product purity.

The moldings according to the invention are particularly preferably used as catalysts in esterification reactions, saponification reactions, water-elimination reactions, hydration reactions, dehydration reactions, aldol condensation reactions, polymerization reactions, di- and oligomerization reactions, alkylation reactions, dealkylation reactions, and transalkylation reactions, cyanohydrin syntheses, acetate-formation reactions, acylation reactions, nitration reactions, epoxidation reactions, sugar inversion reactions, rearrangement reactions, isomerization reactions, etherification reactions, and crosslinking reactions. The reaction here preferably takes place at a temperature of at most 180° C., in particular at most 150° C.

Suitable reactions are also described in Applied Catalysis A: General 221 (2001), 45-62.

The moldings according to the invention can also be used as guard bed, in order to remove undesired impurities from fluids.

Production

The moldings are produced as described for rapid prototyping in the introduction. Reference can be made to the literature cited in the introduction, and also to Gebhardt, Rapid Prototyping, Werkzeuge fur die schnelle Produktentstehung [Rapid prototyping, tools for fast production of products], Carl Hansa Verlag, Munich, 2000, J. G. Heinrich.

Production of the moldings according to the invention uses polymer powders with an average particle size in the range from about 0.5 μm to about 450 μm, particularly preferably from about 1 μm to about 300 μm, and very particularly preferably from 10 to 100 μm. The powder can, as described, also comprise one or more activators. As described, the bonding between the polymer powder particles can take place through treatment with a solvent, through irradiation, or through application of a reactive compound, which is applied as activator compound, thus producing bonding of the polymer particles.

The functionalization of the resultant resin moldings can take place either in the starting powder or in the molding. An example of a process carried out here is sulfonation, as described above. Accordingly, the polymer is functionalized using acidic groups, basic groups, or chelating groups, prior to or after the shaping process.

The invention also provides organic polymer moldings that can be produced by the process described and that have ion-exchanger properties or adsorber properties.

The organic moldings are preferably used as reactor internals in heterogeneously catalyzed chemical reactions, or as adsorbers for the adsorption of ions or of chemical compounds.

The examples below are intended to provide further explanation of the invention, but not to restrict the same.

### EXAMPLES

### Example 1

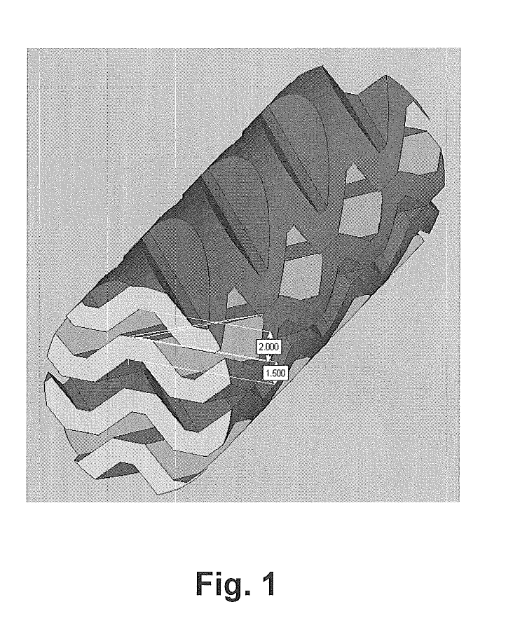

A three-dimensionally structured “intersecting-channel structure” according to FIG. 1 is produced from polystyrene beads. The length of the polymer moldings is 50 mm and their diameter is 14 mm. The shaping process involves three-dimensional printing on a ProMetal RCT S15 (ProMetal RCT GmbH, 86167 Augsburg). After the printing process, air is blown onto the green product to remove unbonded polystyrene beads. The polystyrene molding is then treated with oleum, producing a strongly acidic ion exchanger.

### Example 2

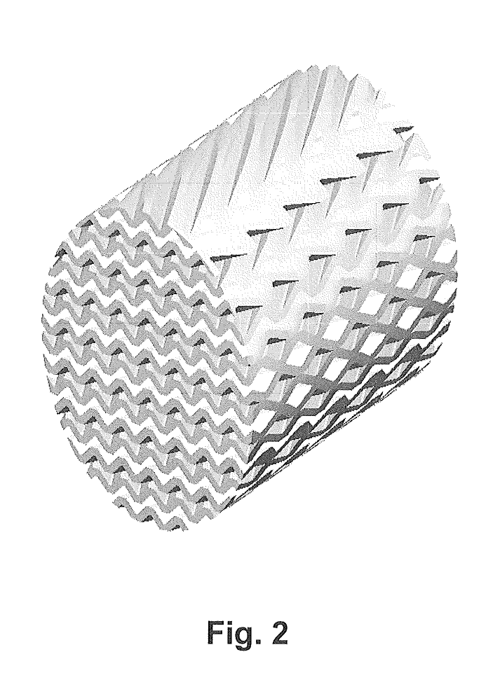

A three-dimensionally structured “intersecting-channel structure” according to FIG. 2 is produced from polystyrene. The length of the polymer moldings is 100 mm and their diameter is 80 mm. The shaping process uses rapid prototyping on a ProMetal RCT S15 (ProMetal RCT GmbH, 86167 Augsburg). Air is blown on to the product to remove loose material, and then the polystyrene molding is treated with oleum to produce a strongly acidic ion exchanger.

### Example 3

A three-dimensionally structured “intersecting-channel structure” according to FIG. 1 is produced from polymethyl methacrylate (=PMMA) beads. The length of the polymer moldings is 50 mm and their diameter is 14 mm. The shaping process involves three-dimensional printing on a ProMetal RCT S15 (ProMetal RCT GmbH, 86167 Augsburg). After the printing process, air is blown onto the green product to remove unbonded polymethyl methacrylate beads. The PMMA molding is then treated with sodium hydroxide solution, producing a weakly acidic ion exchanger.

1-14. (canceled)

15. A process for the production of organic polymer moldings with ion-exchanger properties or with adsorber properties, by means of a powder-based rapid-prototyping process in which a pulverulent organic polymer starting material or starting material mixture is applied in a thin layer to a substrate and then, at selected sites of this layer, is subjected to admixture of a binder and of any necessary auxiliaries, or is irradiated or otherwise treated, so that the powder becomes bonded at these sites, as a result of which the powder becomes bonded not only within the layer but also to the adjacent layers, and this procedure is repeated until the desired shape of the molding has been replicated completely in the resultant powder bed, and then the powder not bonded by the binder is removed, so that the bonded powder is retained in the desired shape, where the starting material itself has the ion-exchanger properties or adsorber properties, or optionally functionalization of the molding takes place after the shaping process, in that the polymer starting material is functionalized with chelating groups, or with basic groups, or with acidic groups, prior to or after the shaping process.

16. The process according to claim 15, wherein the binder is a solvent which at least superficially solvates the polymer starting material, thus producing bonding between the powder particles.

17. The process according to claim 15, wherein the polymer starting material is at least superficially softened by irradiation, and bonding is thus produced between the powder particles.

18. The process according to claim 15, wherein the polymer starting material comprises a reactive compound which is reacted with an applied activator compound, thus producing bonding between the powder particles of the polymer starting material.

19. The process according to claim 18, wherein the reactive compound is a monomer which is also comprised within the structure of the polymer starting material.

20. The process according to claim 15, wherein the polymer starting material is based on poly(meth)acrylic acids, or on poly(meth)acrylates, or on polystyrene, optionally crosslinked prior to or after the shaping process.

21. An organic polymer molding with ion-exchanger properties or with adsorber properties, capable of production by the process according to claim 15.

22. An organic polymer molding with ion-exchanger properties or with adsorber properties, which has one or more channels which are open to the exterior and which run through the molding.

23. An organic polymer molding with ion-exchanger properties or with adsorber properties, which has a surface area/volume ratio at least twice as great as the surface area/volume ratio of a sphere with identical volume.

24. An organic polymer molding with ion-exchanger properties or with adsorber properties, which has the shape of a monolith, and through which a fluid medium can flow, where the monoliths have channels through which a reaction medium flows, and wherein the channels have inclination at an angle in the range from 0° to 70°, preferably from 30° to 60°, with respect to the main direction of flow.

25. The organic polymer molding according to claim 24, wherein the channels have inclination at an angle in the range from 30° to 60°, with respect to the main direction of flow.

26. A packing element wherein a reaction medium flows through a column-shaped reactor which comprises moldings in the form of packings or bed, where the packing is composed of an element or of a multiplicity of elements which form packing sections arranged in a longitudinal direction, each packing element or bed element is composed of a multiplicity of longitudinally oriented layers, each layer comprises closely arranged channels, the channels of adjacent layers cross, and the channels within a packing element or bed element have sidewalls which are impermeable or permeable to the fluids, wherein the moldings have channels through which a reaction medium flows, where the channels have inclination at an angle in the range from 0° to 70°, with respect to the main direction of flow.

27. The packing element according to claim 26, wherein the channels have inclination at an angle in the range from 30° to 60°, with respect to the main direction of flow.
